(19) United States
(12) Patent Application Publication
(10) Pub. No.: US 2009/0090394 A1
(43) Pub. Date: Apr. 9, 2009

(54) DRUM TYPE WASHING MACHINE AND METHOD FOR REMOVING ODOR THEREOF

(75) Inventor: Jung-Hoon KANG, Gyeongsangnam-Do (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/208,956

(22) Filed: Sep. 11, 2008

(30) Foreign Application Priority Data
Sep. 13, 2007 (KR) 10-2007-0093295

(51) Int. Cl. D06B 23/30; B08B 9/093; D06F 39/06

(52) U.S. Cl. 134/22.18; 68/23.4

(57) ABSTRACT

Disclosed is a drum type washing machine and method for removing odor thereof. In the method for removing odor of the drum type washing machine, water is supplied to a drum rotating at high speed and then the water is scattered onto a tub encompassing the drum thus to clean the tub. Accordingly, it is capable of removing the pollutant remaining in the tub, thereby preventing odor from being generated due to rotting of the pollutant. Also, it is capable of preventing odor from being generated due to mold fed on the pollutant in the humid drum type washing machine.

### RELATED APPLICATION

The present disclosure relates to subject matter contained in priority Korean Application No. 10-2007-0093295, filed on Sep. 13, 2007, which is herein expressly incorporated by reference in its entirety.

### BACKGROUND OF THE INVENTION

1. Field of the Invention

The present invention relates to a drum type washing machine and a method for removing odor thereof.

2. Description of the Related Art

In general, a drum type washing machine serves to wash laundry by using a friction force between a rotating drum and the laundry and the laundry dropping from a top to a bottom in the rotating drum. Accordingly, in the drum type washing machine, the laundry is little damaged and is not entangled.

The drum type washing machine includes a cabinet generally forming an external appearance, a tub installed in the cabinet, a drum rotatably installed in the tub, a washing motor rotating the drum, and a drain pump for draining water stored in the tub by outwardly pumping it.

In the meantime, even when the water stored in the tub is drained out, a pollutant (remnants of detergent, lint or the like) is not perfectly drained out with the water, but still remains in the tub.

The pollutant is rotted and thus causes odor. And, in the humid drum type washing machine, the pollutant feeds mold, and this mold also causes odor.

### SUMMARY OF THE INVENTION

Therefore, the present invention is directed to providing a method for removing odor of a drum type washing machine. And, another object of the present invention is to provide a method for removing odor of a drum type washing machine by removing a pollutant remaining in a tub. Further, still another object of the present invention is to provide a drum type washing machine implementing the method for removing odor.

To solve the aforementioned problems, in accordance with the present invention, there is provided a method for removing odor of a drum type washing machine, in which water is supplied to a drum rotating at high speed and then the water is scattered onto a tub encompassing the drum thus to clean the tub. Here, the number of rotation of the drum is approximately 800 rpm, preferably, Preferably, the water supplied to the drum is supplied from a water supply device, and the water is supplied at a time of dehydration after a washing or rinsing process.

Preferably, the water is supplied to the drum continuously for 15 to 50 seconds or periodically.

Preferably, the period is configured with supplying of water for 10 seconds and then stopping supplying of the water for 10 seconds. The period is repeated twice. Alternately, the period is configured with supplying of water for 5 seconds and then stopping supplying of the water for 5 seconds. The period is repeated three times.

Alternately, the water supplied to the drum is water stored in the tub, preferably. Here, the water stored in the tub is water remaining before a draining process after being used for the washing or rinsing process, preferably.

And, to solve the aforementioned problems, in accordance with the present invention, there is also provided a drum type washing machine comprising: a cabinet forming an external appearance; a tub installed in the cabinet so as to store washing water therein; a drum rotatably installed in the tub; a washing motor rotating the drum at high speed and then scattering water onto an inner circumferential surface of the tub so as to impact the inner circumferential surface; and a water supply device supplying water to the drum.

Here, the water scattered onto the inner circumferential surface of the tub is water having been supplied onto an outer circumferential surface of the drum by the water supply device, and the water is supplied at a time of dehydration after a washing or rinsing process, preferably.

Alternately, the water scattered onto the inner circumferential surface of the tub is the washing water stored in the tub, which remains before a draining process after being used for a washing or rinsing process, preferably.

Also, the drum type washing machine further comprises an odor removing button by which a user can rotate the drum in the high speed so as to impact and remove a pollutant attached on the inner circumferential surface by scattering water onto the inner circumferential surface of the tub, preferably.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate preferred embodiments of the invention and together with the description serve to explain the principles of the invention.

In the drawings:

FIG. 1 is a schematic view showing a drum type washing machine operated in a method for removing odor in accordance with a first embodiment of the present invention;

FIG. 2 is an extracted view of a control panel having an odor removing button in FIG. 1;

FIG. 3 is a block diagram showing the method for removing odor in accordance with the first embodiment of the present invention;

FIG. 4 is a graph showing a period supplying water to a drum in FIG. 1;

FIG. 5 is a graph showing a variation of a period supplying water to a drum in FIG. 1;

FIG. 6 is a schematic view showing a drum type washing machine operated in a method for removing odor in accordance with a second embodiment of the present invention; and

FIG. 7 is a block diagram showing the method for removing odor in accordance with the second embodiment of the present invention.

### DETAILED DESCRIPTION OF THE INVENTION

Description will now be given in detail of the preferred embodiments of the present invention, examples of which are illustrated in the accompanying drawings.

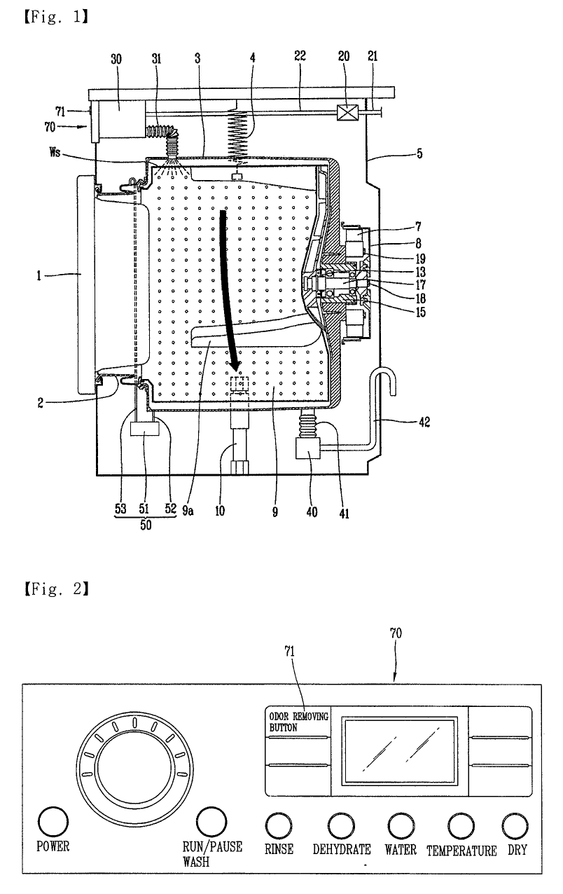

Hereafter, a drum type washing machine in accordance with a first embodiment of the present invention will be described in detail. FIG. 1 is a schematic view showing the drum type washing machine in accordance with the one embodiment of the present invention, FIG. 2 is an extracted view of a control panel having an odor removing button in FIG. 1, and FIG. 3 is a block diagram showing a method for removing odor in accordance with the first embodiment of the present invention.

Referring to FIG. 1, the drum type washing machine operated in the method for removing odor in accordance with the first embodiment of the present invention includes a cabinet 5 forming an external appearance, a tub 3 installed in the cabinet 5 so as to store washing water therein, a drum 9 rotatably installed in the tub 3 and receiving laundry therein, washing motors 7, 8 for rotating the drum 9, a rotation shaft 17 for transferring a rotational force from the washing motors 7, 8 to the drum 9, a bearing 11 for supporting the rotation shaft 17, a sealing member 13 for preventing water between the tub 3 and the drum 9 from penetrating into the bearing 11, a detergent supply device 30 for supplying water mixed with detergent to the tub 3, a water supply device 20 configured with a plurality of valves so as to supply or stop supplying water to the detergent supply device 30, a drain pump 40 for draining the water stored in the tub 3 by outwardly pumping it, a circulation unit 50 for circulating the water stored in the tub 3 therein so as to enhance washing and rinsing performance of the washing machine, and a control panel 70 for controlling an overall operation of the washing machine by receiving a manipulation command from a user.

A door 1 is disposed at a front side of the cabinet 5, and a gasket 2 is installed between the door 1 and the tub 3.

A locking spring 4 for supporting the tub 3 is installed between an upper inner surface of the cabinet 5 and an outer upper surface of the tub 3. A friction damper 10 for reducing vibration of the tub 3 is installed between a lower inner surface of the cabinet 5 and an outer lower surface of the tub 3.

A plurality of lifters 9a for moving the laundry up and down are disposed in the drum 9.

The washing motors 7, 8 consist of a stator 7 implemented as a direct drive type motor and provided with a coil wound at a slot, and a rotor 8 rotating on an outer circumferential surface of the stator 7 and provided with a permanent magnet 12 therein.

The stator 7 is coupled to a rear wall of the tub 3 by a plurality of coupling members 19.

The rotor 8 is coupled to a rear end portion of the rotation shaft 17 by a coupling member 18.

Once the coil of the stator 7 receives a power and thus to become electromagnetic, the rotor 8 is rotated by an interaction between the coil of the stator 7 and the permanent magnet 12 attached into the rotor 8. A rotational force of the rotor 8 is transferred to the drum 9 through the rotation shaft 17.

The bearing 11 is installed in a bearing housing 15 and includes a front bearing positioned at a front side of the rotation shaft 17 and a rear bearing positioned at a rear side of the rotation shaft 17.

The sealing member 13 insertedly installed on the outer circumference of the rotation shaft 17, thereby preventing water between the tub 3 and the drum 9 from penetrating into the bearing 11.

The detergent supply device 30 serves to mix the supplied water with detergent and then supply it to the tub 3 through a supply pipe 31. One exemplary detergent supply device 30 can be configured as followings. That is, the detergent supply device 30 may include a case and a detergent container installed in the case so as to store various kinds of detergent.

A siphon pipe is formed on a bottom of the detergent container. And, a supply opening connected to a connection pipe 22 is formed at the upper side of the case, and a detergent outlet connected to a supply pipe 31 is formed on the bottom of the case.

With such configuration, the water supplied through the connection pipe 22 is mixed with the detergent stored in the detergent container, and then flows out of the detergent container through the siphon pipe when the water mixed with the detergent reaches a specific level. The water mixed with the detergent is supplied to the tub 3 through the supply pipe 31.

A supply pipe 21 connected to an external water supply source and the connection pipe 22 connected to the detergent supply device 30 are installed at the water supply device 20.

A drain pipe 41 connected to the lower side of the tub 3 and a connection pipe 42 connected to an external drain are respectively installed at the drain pump 40.

The circulation unit 50 includes a circulation pump 51, a connection hose 52 connecting the circulation pump 51 to the lower side of the tub 3, and a circulation hose 53 connecting the circulation pump 51 to the upper side of the gasket 2. Here, in case that the circulation pump 51 is operated, the drain pump 40 stops operating, while in case that the drain pump 40 is operated, the circulation pump 51 stops operating.

Referring to FIG. 2, the control panel 70 is provided with an odor removing button 71 by which water is supplied to the drum 9 rotating at high speed and scattered to the tub 3 encompassing the drum 9 so as to clean the tub 3.

Hereafter, it will be explained the method for removing odor of a drum type washing machine in accordance with the first embodiment of the present invention.

Referring to FIGS. 1 and 3, the method for removing odor of the drum type washing machine in accordance with the first embodiment includes rotating the drum 9 in an arrow direction at high speed (S10), supplying water Ws to the drum 9 (S20), stopping supplying the water to the drum 9 (S30), and stopping rotating the drum 9 (S40).

While the drum 9 is rotated at high speed in the arrow direction (S10) and the water is supplied to the drum 9 through the supply pipe 31 (S20), the water is scattered to the tub 3 encompassing the drum 9 thus to clean the tub 3. Accordingly, a pollutant remaining in the tub 3 is detached from the tub 3 and then removed by impact of the scattered water. Thus, the pollutant remaining in the tub 3 is removed, thereby preventing odor from being generated due to rotting of the pollutant. Also, it is capable of preventing odor from being generated due to mold fed on the pollutant in the humid drum type washing machine.

The water is supplied to the drum 9 at a time of dehydration after a washing or rinsing process. That's why the drum 9 is rotated at high speed (approximately 800 rpm) at the time of dehydration and accordingly an scattering force of the water can be strengthened. The water supply to the drum 9 is continuously performed for 15 to 50 seconds and then stopped.

Meanwhile, by repeating a process that the water Ws is supplied to the drum 9 (S20) and then the water supply to the drum 9 is stopped (S30), the water also can be periodically supplied, not continuously.

FIG. 4 is a graph showing a period supplying water to the drum in FIG. 1. Referring to FIG. 4, a period (P1) supplying the water to the drum 9 is configured with supplying of water for 10 seconds and then stopping supplying of the water for 10 seconds. The period is repeated twice. Here, the water supplied to the drum 9 having a water pressure of 0.1 Mpa and a flow velocity of 0.14˜0.16 L/S. And, the amount of water supplied to the drum 9 while the period (water supply for 10 seconds, stopping supplying water for 10 seconds) is repeated twice is approximately 3.2 L.

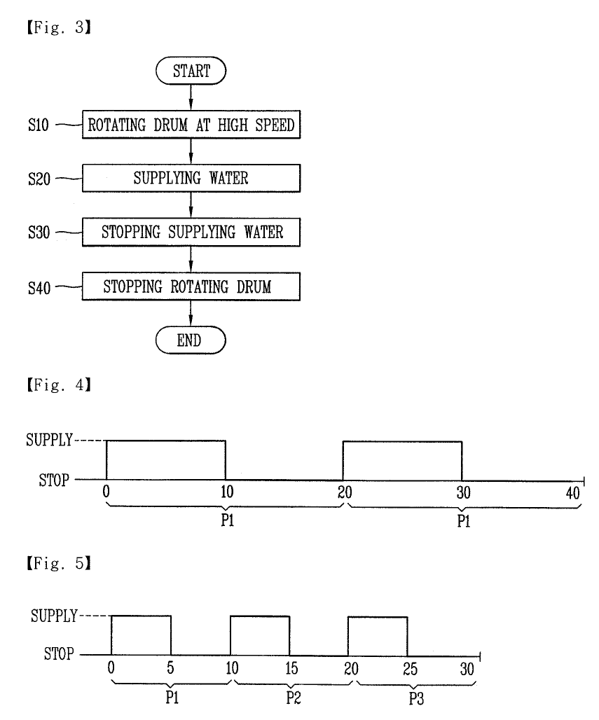

FIG. 5 is a graph showing a variation of a period supplying water to the drum in FIG. 1. Referring to FIG. 5, the period is configured with supplying of water for 5 seconds and then stopping supplying of the water for 5 seconds. The period is repeated three times. Here, the water supplied to the drum 9 having a water pressure of 0.1 Mpa and a flow velocity of 0.14˜0.16 L/S. And, the amount of water supplied to the drum 9 while the period (water supply for 5 seconds, stopping supplying water for 5 seconds) is repeated three times is approximately 2.4 L.

When periodically supplying the water to the drum 9, as a result of test, it is capable of enhancing cleaning performance of the tub 3, particularly of enhancing a cleaning force of a rear side of the tub 3.

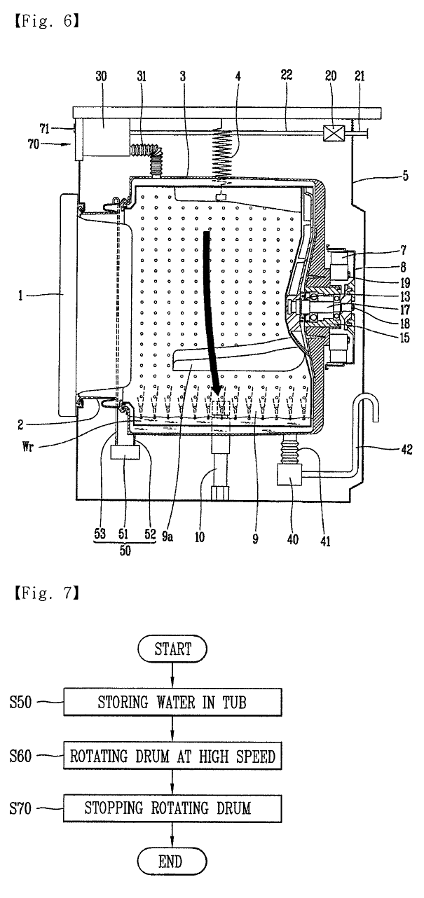

FIG. 6 is a schematic view showing a drum type washing machine operated in a method for removing odor in accordance with a second embodiment of the present invention, and FIG. 7 is a block diagram showing the method for removing odor in accordance with the second embodiment of the present invention.

Hereafter, the method for removing odor of a drum type washing machine in accordance with the second embodiment. Configurations same as those of the drum type washing machine described in the first embodiment will be omitted.

Referring to FIGS. 6 and 7, the method for removing odor of the drum type washing machine in accordance with the second embodiment includes storing water Wr in the tub 3 (S50), rotating the drum 9 in an arrow direction at high speed (S60), and stopping rotating the drum 9 (S70).

While the drum 9 is rotated in the arrow direction at high speed (S60), the water stored in the tub 3 is scattered to the tub 3 thus to clean the tub 3. Accordingly, a pollutant remaining in the tub 3 is detached from the tub 3 and then removed by impact of the scattered water. Thus, the pollutant remaining in the tub 3 is removed, thereby preventing odor from being generated due to rotting of the pollutant. Also, it is capable of preventing odor from being generated due to mold fed on the pollutant in the humid drum type washing machine.

Here, the water stored in the tub 3 is water remaining before a dehydrating process after being used for a washing or rinsing process. Thus, it is not required to additionally supply water, accordingly it is capable of cleaning the tub 3 with reducing water consumption.

As aforementioned, the method for removing odor of the drum type washing machine in accordance with the present invention is characterized in that water is supplied to the drum rotating at high speed and scattered to the tub encompassing the drum thus to clean the tub. Accordingly, it is capable of removing the pollutant remaining in the tub, thereby preventing odor from being generated due to rotting of the pollutant. Also, it is capable of preventing odor from being generated due to mold fed on the pollutant in the humid drum type washing machine.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives modifications, and variations will be apparent to those skilled in the art. The features, structures, methods, and other characteristics of the exemplary embodiments described herein may be combined in various ways to obtain to additional and/or alternative exemplary embodiments.

As the present inventive features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A method for removing odor of a drum type washing machine in which water is supplied to a drum rotating at high speed and then the water is scattered onto a tub encompassing the drum thus to clean the tub.

2. The method of claim 1, wherein the number of rotation of the drum is approximately 800 rpm.

3. The method of claim 1, wherein the water supplied to the drum is supplied from a water supply device.

4. The method of claim 3, wherein the water is supplied at a time of dehydration after a washing or rinsing process.

5. The method of claim 3, wherein the water is supplied to the drum continuously for 15 to 50 seconds.

6. The method of claim 3, wherein the water is supplied to the drum periodically.

7. The method of claim 6, wherein the period is configured with supplying of water for 10 seconds and then stopping supplying of the water for 10 seconds, and the period is repeated twice.

8. The method of claim 6, wherein the period is configured with supplying of water for 5 seconds and then stopping supplying of the water for 5 seconds, and the period is repeated three times.

9. The method of claim 1, wherein the water supplied to the drum is water stored in the tub.

10. The method of claim 9, wherein the water stored in the tub is water remaining before a draining process after being used for the washing or rinsing process.

11. A drum type washing machine comprising:
a cabinet forming an external appearance;
a tub installed in the cabinet so as to store washing water therein;
a drum rotatably installed in the tub;
a washing motor rotating the drum at high speed and then scattering water onto an inner circumferential surface of the tub so as to impact the inner circumferential surface; and
a water supply device supplying water to the drum.

12. The method of claim 11, wherein the water scattered onto the inner circumferential surface of the tub is water having been supplied onto an outer circumferential surface of the drum by the water supply device.

13. The method of claim 12, wherein the water is supplied at a time of dehydration after a washing or rinsing process.

14. The method of claim 11, wherein the water scattered onto the inner circumferential surface of the tub is the washing water stored in the tub.

15. The method of claim 14, wherein the washing water stored in the tub is water remaining before a draining process after being used for a washing or rinsing process.

16. The method of claim 11, further comprises an odor removing button by which a user can rotate the drum in the high speed so as to impact and remove a pollutant attached on the inner circumferential surface by scattering water onto the inner circumferential surface of the tub.
